(19) United States
(12) Patent Application Publication
(10) Pub. No.: US 2026/0066947 A1
(43) Pub. Date: Mar. 5, 2026

(54) SHORT-RANGE WIRELESS COMMUNICATIONS

(71) Applicant: Position Imaging, Inc., Portsmouth, NH (US)

(72) Inventor: Drew Anthony Schena, Manchester, NH (US)

(21) Appl. No.: 19/313,167

(22) Filed: Aug. 28, 2025

Related U.S. Application Data
(60) Provisional application No. 63/689,465, filed on Aug. 30, 2024.

(51) Int. Cl. H04B 5/77; H04L 9/32

(52) U.S. Cl. CPC H04B 5/77; H04L 9/32

(57) ABSTRACT

A method for near field communication (NFC) wireless connectivity, comprising receiving, by an electronic device from a mobile device, an NFC command; issuing, by the electronic device to the mobile device, an NFC response including an incomplete status code to trigger a polling operation by the mobile device; issuing, by the electronic device to the mobile device, the incomplete status code during an execution of the NFC command; and issuing, by the electronic device to the mobile device, a response to the NFC command when the electronic device completes the execution of the NFC command.

### RELATED APPLICATIONS

This application claims priority to U.S. provisional application No. 63/689,465, filed Aug. 30, 2024 and entitled “Short-Range Wireless Communications,” the entirety of which is incorporated by reference herein.

### FIELD OF THE INVENTION

The invention relates generally to short-range communications between wireless electronic devices, and more specifically to computer security and compatibility for short-range near-field communication (NFC) wireless connectivity between such devices.

### BACKGROUND

Near-field communication (NFC) is a short-range wireless protocol technology gaining in popularity because it allows NFC protocol-enabled devices that wirelessly communicate with smartphones or other contactless smart devices having readers when they are within a few centimeters of each other. This can be used in a variety of applications, ranging from contactless payment systems to credit card authentication to interactive gaming where physical game components can communicate with digital platforms, for example, an NFC-equipped toy and a gaming console, electronic pass keys used in building security systems, and mass transit fare card systems.

NFC signals are generally structured around an electronic exchange of commands and responses allowing for a transmission of small payloads of data between two NFC devices, for example, an NFC tag and a mobile device having an NFC reader, such as an Android-powered smartphone, but not limited thereto. For example, in applications involving an NFC reader and an electronic tag engaged in wireless communication, the NFC reader will issue a command, and the tag will issue a response. A wireless data communication between the reader and tag can be terminated either by the reader or when the tag moves out of range, for example, a distance of 4 cm typically required to allow an NFC connection. Here, there is often a response timeout on the reader after which it will no longer accept a response for the previous command. However, some NFC communications may involve operations which will require extended periods of time for a data exchange, for example, 100 ms or more. For example, it may be desirable to perform a cryptographic verification of a signature in order to determine the appropriate response to a command (to reject them if the signature is invalid), which can take a relatively long time on a microcontroller. This may cause the NFC Application Programming Interfaces (APIs) on some devices to be unable to receive the responses to a command. Furthermore, the lack of received response may cause the phone to automatically end the NFC session, disrupting the ability to communicate with the tag until the mobile device is pulled away and direct contact by tapping the reader against the tag again.

### SUMMARY

All examples and features mentioned below can be combined in any technically possible way.

In one aspect, a method for near field communication (NFC) wireless connectivity comprises receiving, by an electronic device from a mobile device, an NFC command; issuing, by the electronic device to the mobile device, an NFC response including an incomplete status code to trigger a polling operation by the mobile device; issuing, by the electronic device to the mobile device, the incomplete status code during an execution of the NFC command; and issuing, by the electronic device to the mobile device, a response to the NFC command when the electronic device completes the execution of the NFC command.

In some embodiments, during the execution of the NFC command, the mobile device performs a polling operation that includes sending a response retrieval command to the electronic device requesting the response to the NFC command and the electronic device, in response, issues the incomplete status code to the mobile device.

In another aspect, a method for structuring NFC communication between a mobile device and an electronic tag comprises generating, by the mobile device, an NFC command comprising a unique command identifier and a command payload; receiving, by the electronic tag, the NFC command and storing the unique command identifier in a response buffer; issuing, by the electronic tag, an NFC response comprising the same unique command identifier, a status code, and a response payload; updating, by the electronic tag, the response buffer with the status code and response payload; and enabling, by the mobile device, retrieval of the response buffer contents using the unique command identifier during polling operations.

In another aspect, a method for structuring NFC communication between a mobile device and an electronic tag comprises generating, by the electronic tag, a unique command identifier (a n-once); requesting, by the by the mobile device that unique command identifier; receiving, by the mobile device that unique command identifier; generating, by the mobile device, an NFC command comprising that unique command identifier and a command payload; receiving, by the electronic tag, the NFC command and storing the unique command identifier in a response buffer; issuing, by the electronic tag, an NFC response comprising the same unique command identifier, a status code, and a response payload; updating, by the electronic tag, the response buffer with the status code and response payload; enabling, by the mobile device, retrieval of the response buffer contents using the unique command identifier during polling operations.

In another aspect, an electronic tag configured for near-field communication (NFC) with a mobile device comprises a processor configured to execute NFC command instructions; a memory storing program code and a response buffer for NFC command responses; an NFC transceiver configured to receive NFC commands and transmit responses; and one or more sensors configured to detect environmental or motion conditions, wherein the response buffer stores interim and final responses to the NFC commands, and is accessible by the mobile device during polling operations.

### BRIEF DESCRIPTION OF THE DRAWINGS

The above and further advantages of this invention may be better understood by referring to the following description in conjunction with the accompanying drawings, in which numerals indicate like structural elements and features in various figures. The drawings are not necessarily to scale, emphasis instead being placed upon illustrating the principles of the invention.

FIG. 1 is a block diagram of a system including various electronic components that are engaged in short-range wireless communications and in which embodiments of the present inventive concept can be practiced.

FIG. 2 is a block diagram of the electronic tag of FIG. 1, in accordance with some embodiments.

FIG. 3 is a flow diagram of a method for NFC communications, in accordance with some embodiments.

FIG. 4 is a diagram illustrating a handshaking operation between an NFC reader and an electronic tag, in accordance with some embodiments.

FIG. 5 is a diagram illustrating NFC communication command and response messages, in accordance with some embodiments.

### DETAILED DESCRIPTION

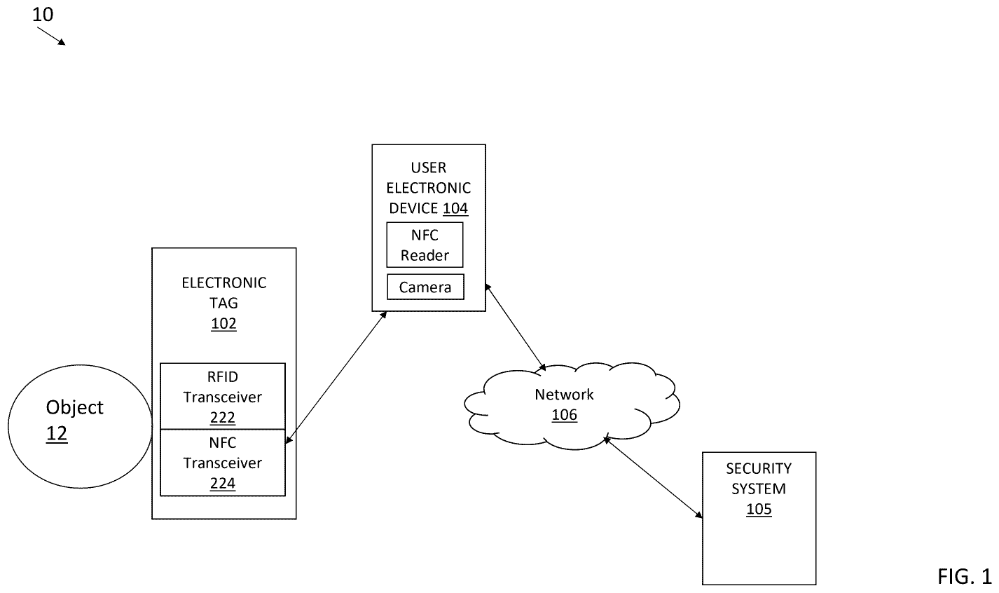

FIG. 1 is a block diagram of a system 10 including various electronic components that are engaged in short-range wireless communications and in which embodiments of the present inventive concept can be practiced. In some embodiments, the short-range wireless communications include NFC communications between an electronic tag 102 and a user electronic device 104 such as a smartphone or other mobile device. Although the disclosure describes in some embodiments communications between an NFC device that can read and write passive NFC tags or the like, other NFC communications may apply such as peer-to-peer communications between NFC peers. The system 10 may provide other short-range communications where the tag 102 includes a radio frequency identification (RFID) so that an RFID device can automatically identify and track tags attached to objects. With the increased adoption of radio frequency identification (RFID) contactless smart-cards to support a broad range of applications, such as access, payment, and ticketing, and the commercial availability of NFC-enabled devices such as cell phones, the convergence of NFC with RFID by the system 10 may be of interest. To achieve this, in some embodiments, the tag 102 may include an RFID transceiver 222 and an NFC transceiver 224. In other embodiments, the NFC transceiver 224 only is provided.

FIG. 1 also illustrates a communications network 106 such as a private network (i.e., intranet, Wi-Fi) 106 and/or a public network (e.g., the Internet) that provides for electronic communications with a security system 105 which can perform cryptographic verification, scanning, and/or other operations related to an NFC communication. For example, data received via an NFC and/or RFID communication from the tag 102 to the user electronic device 104 can be sent and received over a Wi-Fi network, or via the Internet with other computers, such as the security system 105.

As one function, the electronic tag 102 when coupled to an object 12 can be used to track the object 12. For example, the tag 102 includes detectors that can detect a movement of the object, and the location of the object can be tracked throughout a building or other indoor or outdoor region comprising electronic devices for communicating with the tag 102, for example, described in U.S. patent application Ser. No. 17/588,993 filed Jan. 31, 2022 entitled “ARTICLE-IDENTIFICATION-AND-LOCATION DEVICE SYSTEMS AND METHODS OF USING SAME,” the contents of which are incorporated by reference herein in their entirety. However, the electronic tag 102 may have other functions. For example, The tag 102 can receive and verify cryptographically signed data which it can then display on the electronic ink (e-ink) screen or the like, for example, to emulate a conventional non-circuit (e.g., paper, plastic, etc.) luggage tag.

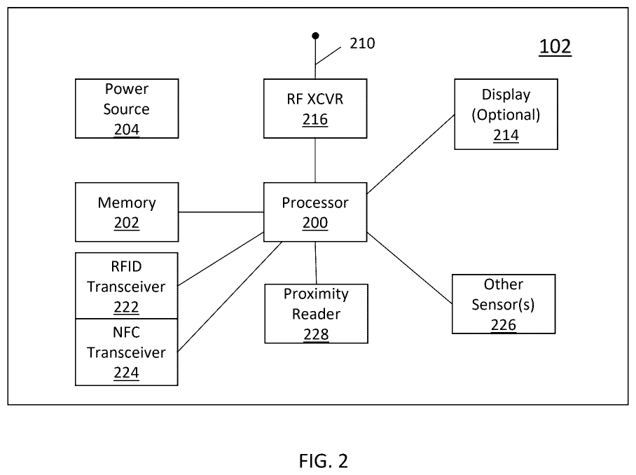

FIG. 2 is a block diagram of the electronic tag 102 of FIG. 1, in accordance with some embodiments. Although a tag is shown and described, other constructions may equally apply such as clips and so on, so long as the construction permits the electronic tag 102 to be coupled to or integrated with an object. As described herein, the electronic tag 102 can be activated by the user electronic device 104 using an NFC communication exchange. In one embodiment, the system is programmed to have the user electronic device 104 tap the tag 102 to initiate an NFC communication.

As shown in FIG. 2, the electronic tag 102 includes a processor or processing unit 200, memory 202, an RF receiver 216 (or, in another embodiment, an RF transceiver), and a power source 204 such as a battery. The tag 102 and the foregoing contents can be disposed of on or within a substantially flat, thin tag body.

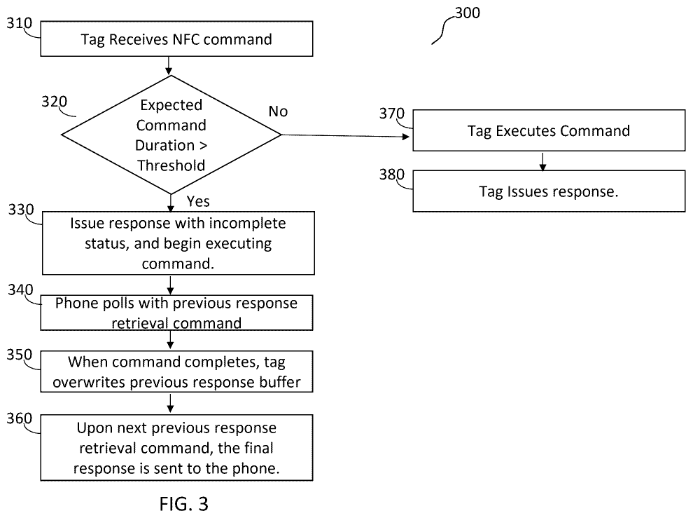

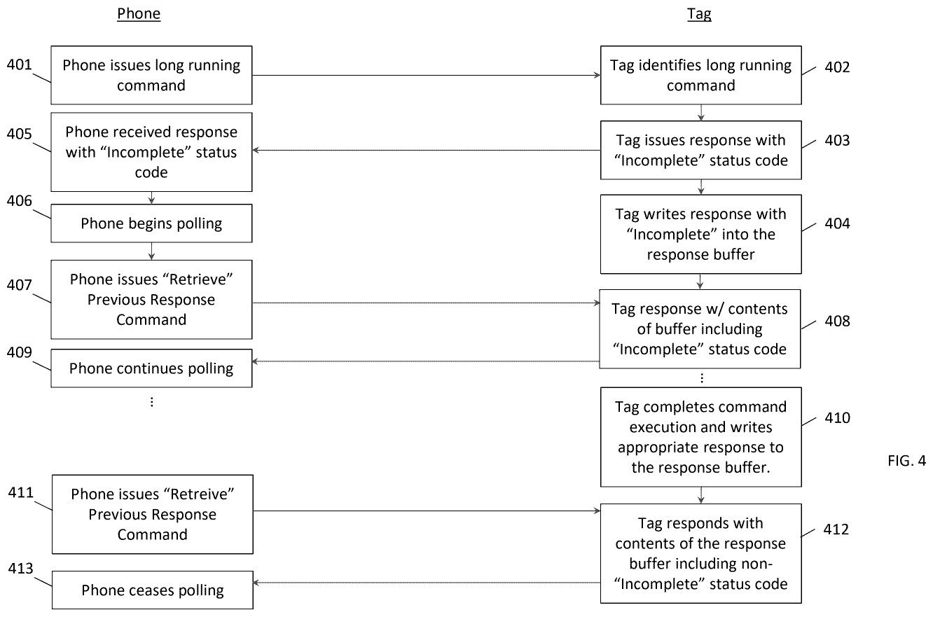

The memory 202 stores program code for controlling the other electronic components of the tag 202 and for performing some or all method steps described in FIGS. 3 and 4. The memory 202 and the information and program code it stores can be physically distributed among the various components of the tag 102. Also stored in memory 202 are one or more response buffers, described below.

The RF receiver 216 has, in one embodiment, an antenna 210 for wireless communications, namely, receiving radio signals, and operates as an NFC antenna at frequencies of 13.56 MHz and has a short-range, for example, 4 centimeters or less. For applications including direct contact, or tapping, between the tag 102 and a reader, e.g., a mobile device such as a smartphone, other wireless connectivity technology using magnetic field induction for forming an NFC communication between the two devices may equally apply. In some embodiments, the proximity reader 228 includes the antenna 210 for interacting with the user electronic device 104.

In some embodiments, the electronic tag 102 includes a plurality of sensors 226, including but not limited to a combination of gyroscopic sensors, altimeters, accelerometers, motion sensors, and force sensors, The tag 102 may use these sensors 226 to determine pressure, temperature, humidity, contact, or other environmental condition.

The processor or processing unit 200 is electronic circuitry adapted to execute the instructions of the program code stored in memory 202 that controls the operation of the tag 102, for example, the processing of data received by the sensors and the user electronic device 104, such as a smartphone.

In some embodiments, the tag 102 may include an optional display 214, which includes a variable, dynamic, and programmable screen for displaying information depending on the application of the tag 102. For example, the display 214 may display an acknowledgement that the tag 102 has been activated after tapping with the user device 102 and forming an NFC communication. Embodiments of the display 214 include, but are not limited to, liquid crystal displays (LCD), organic light-emitting diode (OLED) displays, and electronic paper (i.e., electronic ink or e-ink) displays.

Although not shown, in some embodiments, the tag 102 has a battery or other power source. In other embodiments, the tag is battery-less. Here, the mobile device 104 can output enough power from its NFC chip (not shown) for the tag 102 to wirelessly receive it and run. As soon as the tag 102 is powered up, it can output NFC messages written into the memory 202.

FIG. 3 is a flow diagram of a method 300 for NFC communications, in accordance with some embodiments. In describing the method 300, reference may be made to elements of FIGS. 1 and 2.

In particular, FIG. 3 illustrates a method for managing NFC communications between a mobile device and an electronic tag, particularly when command execution may exceed the standard NFC timeout window. The method 300 begins with the tag receiving an NFC command from the mobile device. If the command is expected to complete quickly, the tag executes it and returns a final response. However, for longer-running operations, such as cryptographic verification or e-ink screen updates, the tag instead issues an “Incomplete” status code. This interim response prevents the NFC session from timing out and prompts the mobile device to initiate a polling sequence using response retrieval commands. The tag continues to return the “Incomplete” status until the operation is complete, at which point it updates the response buffer with a final result. The next polling request retrieves this final response. The polling interval may be dynamically adjusted based on command type or elapsed time. This approach enables secure, asynchronous communication over NFC, allowing time-intensive operations to complete without breaking the session, and is particularly useful for applications requiring high-integrity command validation, such as secure tag updates in airline or logistics environments.

More specifically, at step 310, an NFC command is received by the electronic tag 102 from an NFC reader of the user electronic device 104 (shown for example in FIG. 4). It is well-known that NFC requires a response from the tag 102 to the command. However, if the response is not received by the reader within a predetermined amount of time, then a timeout may be generated after which it will no longer accept a response for the command.

At decision diamond 320, a determination is made whether or not the command exceeds a threshold. The threshold is used to determine whether the tag should respond immediately with the final result if the execution is fast or send an incomplete status code to trigger polling by the mobile device if execution is slow. For example, a cryptographic verification of a signature may be performed in order to determine the appropriate response to a command (to reject them if the signature is invalid), which can take a relatively long time on a microcontroller. This caused the NFC APIs on some mobile devices, such as the user electronic device phone 104 to be unable to receive the responses to these commands. In some embodiments, the threshold is between 5 ms and 100 ms. Other embodiments do not require an explicit time threshold, and instead include certain categories of actions that might cause a command to be categorized as “long running”, for example cryptographic verification, or updating the e-ink screen.

If no, i.e., the command duration is less than the threshold, then the method proceeds to step 370, where the tag executes a command then to step 380 where the tag issues a response. If yes, then the method 300 proceeds to step 330 where the tag issues a response with an “Incomplete” status code, i.e., when the execution is too slow per the threshold. This response satisfies the phone's need for a response to allow further communication, and at step 340 the phone can begin polling with the previous response retrieval command. While the command remains incomplete the phone will continue to see the incomplete status code. When the command completes the tag will simply overwrite the previous response buffer, rather than issuing a real response, and the next time the phone polls, it will receive a response containing a success or error status code as appropriate.

In some embodiments, the polling interval is dynamically adjusted. The polling interval may be defined as the time duration between successive response retrieval commands sent by the mobile device to the electronic tag after receiving an “Incomplete” status code. Polling can be conditional, and only begins if the command execution time exceeds the threshold. The mobile device may adjust how often it polls based on factors such as the type of command, the expected duration (inferred from the “Incomplete” status), or the absence of a final response over time. For example, when the tag sends an incomplete status code, the mobile device can begin polling, i.e., repeatedly sending requests to check if the tag has completed execution and updated the response buffer. The interval between these polling requests is the polling interval.

When the command is complete, then at step 350 the tag overwrites the previous response buffer.

Accordingly, the extra time from the delayed responses allows us to perform verifications which allow us to be very confident that the commands are coming from us and not a bad actor. There are some other approaches that could accomplish this without needing the extra time, but they would require a long pairing time up front and a more complex backend. In an ideal world, this wouldn't be needed as the NFC readers would be capable of handling delayed responses, but that's just not how readers are made to work right now so this system lets us work with just about anything.

The method 300 can be applied each time an NFC command is issued that requires security (e.g., any time an NFC command will be used to update the screen, or any other info that only we or the airlines should have control over).

FIG. 4 is a diagram illustrating a handshaking operation between an NFC reader and an electronic tag, in accordance with some embodiments. FIG. 4 illustrates how current response buffers and previous response buffers mentioned in FIG. 3 are used.

The electronic tag incorporates a response buffer, namely, a dedicated memory structure designed to temporarily store the most recent NFC command response. This buffer is updated each time the tag issues a response, with the exception of responses to polling requests (i.e., previous response retrieval commands), which do not trigger a buffer overwrite. The buffer holds structured data including a unique command identifier, a status code (such as “Incomplete,” “Success,” or “Error”), and an optional payload containing the result of command execution.

When the mobile device sends a previous response retrieval command, it accesses the contents of this buffer to determine the current state of the command. If the buffer still contains the original command's unique identifier and an “Incomplete” status code, the mobile device infers that the command is still being processed. This enables asynchronous communication, allowing the mobile device to poll the tag repeatedly without requiring a new NFC session.

Upon completion of the command execution-such as cryptographic verification or display update—the tag overwrites the buffer with a final response. This updated response retains the original command's unique identifier but replaces the status code with a terminal value (e.g., “Success” or “Error”) and may include a verified payload. The next polling request from the mobile device retrieves this final response, confirming the completion of the command and enabling appropriate follow-up actions.

This buffer-based architecture ensures reliable NFC communication even in scenarios involving extended processing times, and supports secure, stateful interactions between the tag and mobile device without requiring persistent connectivity or re-initiation of the NFC session.

The process in FIG. 4 starts when the mobile device transmits a command (401), which the tag receives and evaluates to determine the expected execution time (402). If the command requires extended processing, the tag writes an “Incomplete” status to its response buffer (404) and sends (403) this status back to the mobile device (405). Upon receiving the “Incomplete” status, the mobile device initiates a polling sequence (406), repeatedly sending response retrieval commands (407) while the tag continues executing the original command. This polling continues (409) until the tag completes processing and updates the response buffer with the final result (410). The next polling request from the mobile device retrieves this final response, allowing the communication to conclude successfully (411-413). This approach ensures that longer-running commands do not disrupt the NFC session and maintains reliable communication between the devices.

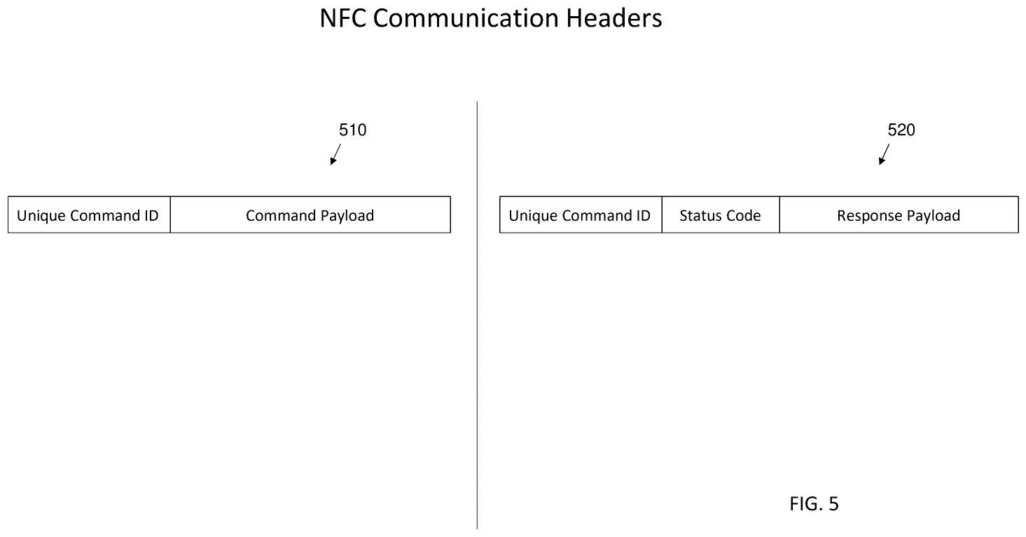

FIG. 5 presents a diagram that outlines the structure of NFC communication messages, including commands 510 and responses 520, in accordance with certain embodiments. These messages—comprising headers, payloads, and other components—can be utilized to influence the timeout duration that an NFC reader uses to determine when to terminate a communication session due to a perceived absence of a tag. Typically, when a reader initiates communication with a tag, it transmits a signal and waits for a response within a predefined time window. If no response is received during this interval, the reader may generate an error or terminate the session, assuming the tag is no longer present. This timeout period can vary depending on the implementation, with common durations around 100 milliseconds, though other values may be used. As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated that various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure, or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, inner, and outer, interior, and exterior, and vertical and horizontal are intended for convenience of description, not to limit the described systems and methods or their components to any one positional or spatial orientation. Accordingly, the foregoing description and drawings are by way of example only, and the scope of the invention should be determined from proper construction of the appended claims, and their equivalents.

What is claimed is:

1. A method for near field communication (NFC) wireless connectivity, comprising:
receiving, by an electronic device from a mobile device, an NFC command;
issuing, by the electronic device to the mobile device, an NFC response including an incomplete status code to trigger a polling operation by the mobile device;
issuing, by the electronic device to the mobile device, the incomplete status code during an execution of the NFC command; and
issuing, by the electronic device to the mobile device, a response to the NFC command when the electronic device completes the execution of the NFC command.

2. The method of claim 1, wherein during the execution of the NFC command, the mobile device performs a polling operation that includes sending a response retrieval command to the electronic device requesting the response to the NFC command and the electronic device, in response, issues the incomplete status code to the mobile device.

3. The method of claim 1, wherein the polling interval is dynamically adjusted based on the expected processing time of the command.

4. The method of claim 1, wherein the electronic device includes an electronic tag.

5. The method of claim 1, wherein, the electronic device includes at least one response buffer and a secure element for cryptographic operations.

6. The method of claim 5, further comprising:
outputting, by the mobile device, at least one response retrieval command of a polling request of the polling operation;
responding, by the electronic device, to each polling request with contents of the response buffer; and
updating by the electronic device the response buffer with a result of a completed command.

7. The method of claim 5, wherein the response buffer includes a unique command identifier to correlate responses with the originating command.

8. The method of claim 1, wherein the mobile device ceases polling only after receiving a response with a status code other than the incomplete status code.

9. A method for structuring NFC communication between a mobile device and an electronic tag, comprising:
generating, by the mobile device, an NFC command comprising a unique command identifier and a command payload;
receiving, by the electronic tag, the NFC command and storing the unique command identifier in a response buffer;
issuing, by the electronic tag, an NFC response comprising the same unique command identifier, a status code, and a response payload;
updating, by the electronic tag, the response buffer with the status code and response payload;
enabling, by the mobile device, retrieval of the response buffer contents using the unique command identifier during polling operations.

10. The method of claim 9, wherein the status code comprises an incomplete value indicating that the command is still being processed.

11. The method of claim 9, wherein the response payload includes confirmation that the command payload was cryptographically verified.

12. The method of claim 9, wherein the response buffer is configured to store multiple command identifiers and their associated responses.

13. The method of claim 9, wherein the mobile device uses the unique command identifier to correlate polling requests with specific commands.

14. The method of claim 9, wherein the response buffer is cleared or overwritten upon successful transmission of the final response.

15. A method for structuring NFC communication between a mobile device and an electronic tag, comprising:
generating, by the electronic tag, a unique command identifier (a n-once);
requesting, by the by the mobile device that unique command identifier;
receiving, by the mobile device that unique command identifier;
generating, by the mobile device, an NFC command comprising that unique command identifier and a command payload;
receiving, by the electronic tag, the NFC command and storing the unique command identifier in a response buffer;
issuing, by the electronic tag, an NFC response comprising the same unique command identifier, a status code, and a response payload;
updating, by the electronic tag, the response buffer with the status code and response payload;
enabling, by the mobile device, retrieval of the response buffer contents using the unique command identifier during polling operations.

16. The method of claim 15, wherein the status code comprises an incomplete value indicating that the command is still being processed.

17. The method of claim 15, wherein the response payload includes confirmation that the command payload was cryptographically verified.

18. The method of claim 15, wherein the response buffer is configured to store multiple command identifiers and their associated responses.

19. The method of claim 15, wherein the mobile device uses the unique command identifier to correlate polling requests with specific commands.

20. The method of claim 15, wherein the response buffer is cleared or overwritten upon successful transmission of the final response.
